(19) United States
(12) Patent Application Publication
(10) Pub. No.: US 2007/0139553 A1
(43) Pub. Date: Jun. 21, 2007

(54) Remote monitoring system and method responsive to a signal reaching a threshold

(76) Inventors: Thomas F. Kister, Chalfont, PA (US); Robert H. Folk, Narberth, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/312,262

(22) Filed: Dec. 20, 2005

(51) Int. Cl. H04N 11/00

(52) U.S. Cl. 348/468

(57) ABSTRACT

An electronic device and method for controlling the electronic device are disclosed. The electronic device includes at least one interface, a processor and a video processor. The interface receives a first audio signal and a first video signal. The processor receives either the first audio signal or the first video signal and compares a characteristic of that signal against a threshold value. The processor also outputs a first control signal, based on the comparison. The video processor receives the first control signal and outputs a composite video signal in response to the first control signal comprised of a television program or content retrieved from a DVD and an icon.

### FIELD OF THE INVENTION

This invention relates in general to electronic devices, and more specifically, to an electronic device for monitoring a location.

### BACKGROUND OF THE INVENTION

One of the areas of growth in electronic devices is related to their use in monitoring locations, such as in surveillance systems. In a surveillance system, audio and/or video signals are captured at a location and are provided to an output device at another location. A user at the other location receives these audio and/or video signals and takes appropriate action.

There are various surveillance systems available today. One such system includes a microphone, a transmitter, and an audio output device such as a speaker. The microphone and the speaker are operatively coupled to the transmitter. The microphone captures an audio signal at a remote location and provides it to the transmitter. The transmitter then transmits the audio signal to the audio output device. Upon receiving the audio signal, the audio output device provides the audio output to a user of the surveillance system. However, the user of the surveillance system has to physically go and check if any attention is needed at the remote location of the surveillance.

### BRIEF DESCRIPTION OF THE FIGURES

The present invention is illustrated by way of example and not limitation in the accompanying figures, in which like references indicate similar elements, and in which:

FIG. 1 is an illustrative system for remote monitoring;

FIG. 2 is a block diagram illustrating an electronic device for displaying remote monitoring information; and

FIG. 3 is a flowchart illustrating a method for displaying remote monitoring information.

Skilled artisans will appreciate that elements in the figures are illustrated for simplicity and clarity and have not necessarily been drawn to scale. For example, the dimensions of some of the elements in the figures may be exaggerated relative to other elements, to help to improve understanding.

### DETAILED DESCRIPTION

The terms such as ‘comprises,’ ‘comprising’, ‘includes’, ‘including’, or any other variation thereof, are intended to cover a non-exclusive inclusion, such that a process, method, article, or apparatus that comprises a list of elements that not only includes those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term ‘another’, as used herein, is defined as at least a second or more. The terms ‘including’ and/or ‘having’, as used herein, are defined as comprising. The term ‘coupled’, as used herein is defined as connected, although not necessarily directly, and not necessarily mechanically.

A system and method are described that provide audio and/or video signals to an end user when certain conditions are met. This allows a user to continue what he was doing, such as watching television, without continuously being interrupted by receiving irrelevant information from a monitored location. As an example, if a baby in a crib begins to cry loudly, the amplitude of the cry is measured and if it is above a threshold, an icon can be displayed on a television alerting a parent that the baby is crying. The parent can then use a remote control to either switch from the currently viewed television program to view video of the baby or ignore the icon and continue to watch the program and allow the baby to fall back asleep on her own. In this manner the parent can still monitor his baby but only be interrupted when the baby is crying loudly and not when the baby is making small noises when she rolls over, for example.

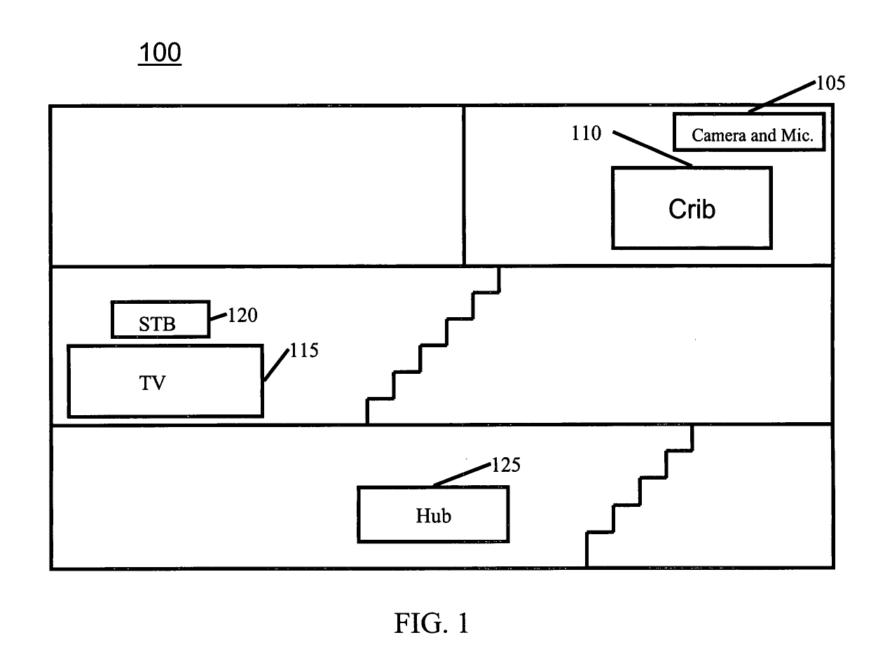

FIG. 1 is a diagram of a remote monitoring system 100 implemented in a home environment. System 100 includes a camera/microphone combination 105 that captures video and audio signal emanating from crib 110. The signals captured by camera/microphone 105 are transmitted via a network in the home (not shown). This network will typically by a Local Area Network (LAN) but it can also include portions of a Wide Area Network (WAN), a Metropolitan Area Network (MAN), a Wireless LAN (WLAN), and the Internet or any other wired or wireless network or protocol. The signals are then forwarded to either set-top box (STB) 120 or hub or residential gateway 125 where the signals are then forwarded to television 115 when certain conditions are met.

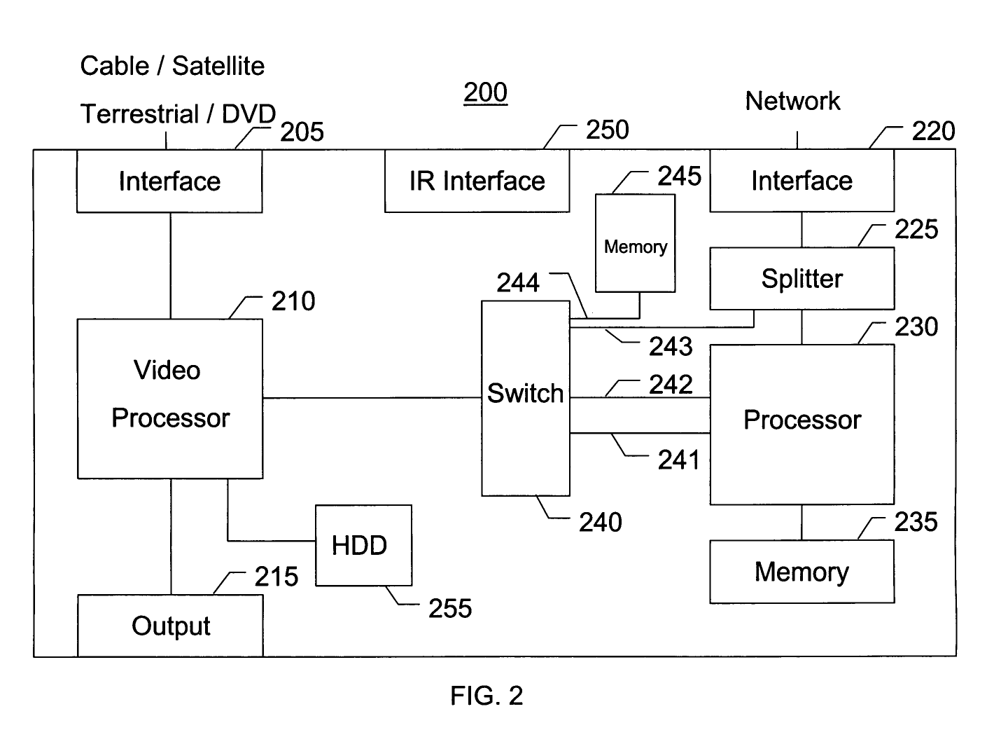

FIG. 2 is a block diagram illustrating further details of a device 200 that may be implemented as STB 120 or hub 125. Device 200 includes interface 205. Interface 205 is coupled to an external network such as a cable, satellite or terrestrial network (not shown) or to a local storage device such as a DVR or DVD player. Interface 205 receives content, such as television signals, and selects one signal to forward to video processor 210 when many are present. Video processor 210 converts the received content signal into one that may be rendered by a display device such as a television or a stereo. Video processor 210 may decrypt, decode or otherwise process the selected signal. Video processor 210 outputs the reformatted content to interface 215 which forwards the signals to the display device such as television 115. In addition, there is a hard-disk drive (HDD) 255 that is used to store and buffer signals output by interface 205. There are other details in these units that are not shown but are known by those of ordinary skill in the art and need not be described here further.

Device 200 also has a second interface 220 that is coupled to the home network and therefore camera/microphone 105. Interface 220 receives the signals output from camera/microphone 105 and forwards them to splitter 225. Splitter 225 separates the audio and video signals from each other for independent processing. One signal (either audio or video) is forwarded to processor 230. Processor compares that signal against a threshold value stored in memory 235.

Switch 240 receives four signals 241, 242, 243 and 244. Signal 241 is a control signal output by processor 230 instructing switch 240 to output particular data. Switch 240 receives audio and video signals 241 and 242 input into interface 220. Signal 244 is icon data stored in memory 245. Various aspects of device 200 are controlled by receiving user input signals via IR interface 250.

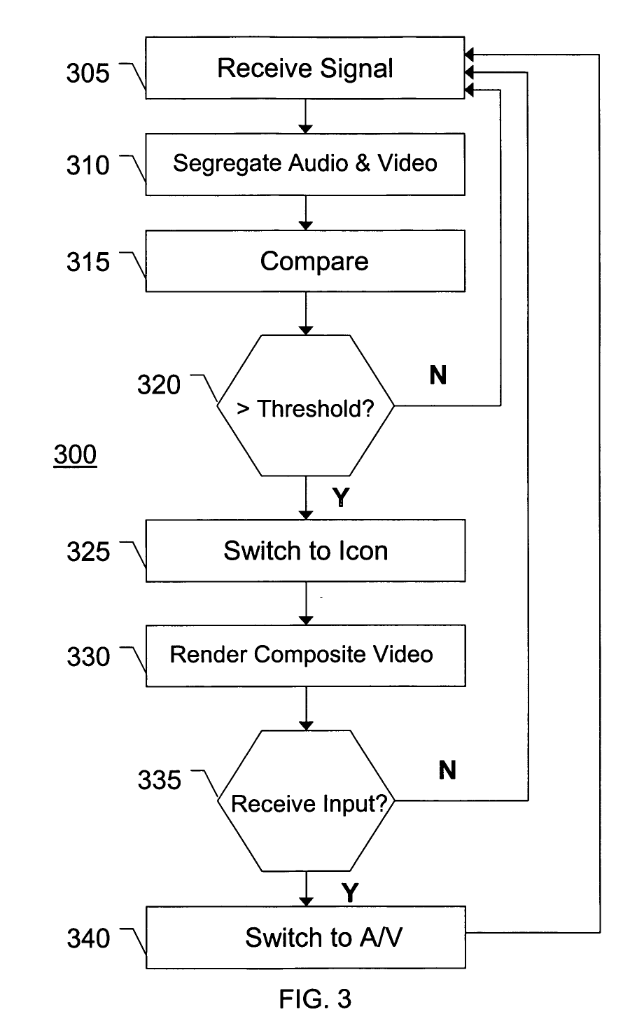

Operation of device 200 is described in conjunction with process 300 shown in FIG. 3. The process begins at step 305 when interface 220 receives a signal from camera/microphone 105 over a network. As an example, the signal received could be in a packet. Assuming camera/microphone 105 outputs both audio and video signals, the two are separated from each other by splitter 225. This step, and splitter 225 in FIG. 2, is optional if the camera/microphone 105 only outputs one type of data (audio or video but not both). A characteristic of the signal from splitter 225 is then compared against a threshold value stored in memory 235 at step 315. This comparison can occur in at least one of two ways.

If processor 230 receives audio data, either from splitter 225 or directly from interface 220, it first determines a characteristic, such as the magnitude, of the audio signal. The magnitude may be an average of audio signals corresponding to 0.1 msec or 5 seconds, or any other time amount, of audible content. Alternatively, the magnitude maybe determined based on the magnitude of an audio signal contained in a single packet or other quantifiable amount based upon the transmission protocol. This magnitude is then compared against the threshold value retrieved from memory 235.

On the other hand, if processor 230 receives video data, it will look to the video data itself in one illustrative system. In this case, the received video signal merely contains the differences between the current frame for display and the previous frame. For large changes from one frame to the next, the amount of data needed to convey those changes increases. Thus, processor 230 may compare the amount of video data it receives to render the next frame based on the current frame against a threshold value stored in memory 235. This is done at step 315.

If the data signal is below or equal to a threshold at step 320, the process returns to step 305 so that device 200 continues to receive streaming audio/video from camera/microphone 105. If the data signal is above the threshold value at step 320, processor 230 issues a control signal 241 instructing switch 240 to output icon data from memory 245 and instructing video processor 210 to blend or overlay the icon onto the television or DVD picture signal at step 325. At step 330, processor video receives that icon data from switch 240 and outputs a composite video signal comprised of the selected program or movie received on interface 205 and the icon. The icon will typically be small and be placed in the corner of the screen on television 115. The icon could be an image, such as of a crying baby, or it could be text such as “Baby Alert.”

At step 335, the television viewer may decide to ignore this alert. This is appropriate if the viewer is trying to teach his child to sleep and does not want to intervene too often. The user may push an appropriate button on a remote control to have the icon removed from the screen, or in alternative systems device 200 times-out the icon after a preset period of time in which no input is received from the viewer. In either case, the process returns to step 305 to receive additional data from interface 220.

If at step 335 the user pushes an appropriate button on a remote to view the video images captured by camera/microphone 105, IR interface 250 forwards an instruction (via directly or via video processor 210 or 230) to switch 240 to start forwarding either the audio signal (e.g., 242), video signal (e.g., 243) or both to video processor 210. Video processor 210 then switches its output from the video stream received on interface 205 to outputting the A/V stream delivered by camera/microphone 105 via switch 240 at step 340. In this way the parent can check on his child using the camera/microphone 105 to see if he needs to go to the crib and soothe the infant.

As an optional feature, video processor 210 recognizes when the parent switches from watching his program to viewing his child and can start recording the program (if permissible) onto hard-drive 255. This way the parent can check on his child and not miss any of the program he was watching previously.

In another illustrative system, video processor 210 outputs a composite video signal that includes both the signal received on interface 205 and the signal received on interface 220 in a picture-in-picture mode. In yet another illustrative system, device 200 is coupled to both television 115 and camera/microphone 105 over the same network.

There are many modifications that may be made to the systems and methods previously described. For example, splitter 225 may be omitted and the work of extracting the portion of the signal to use in the comparison falls onto processor 230. Alternatively, processor 230 receives both audio and video signals and compares both against a threshold value. Only if one or both exceeds its respective threshold is the icon displayed on the screen. Processor 230 may also examine other characteristics of the signal such as a duration of the audio signal exceeding a particularly threshold. To put it another way, processor 230 may have multiple thresholds such a peak threshold for loud sounds and a second threshold that isn't as large in magnitude as the peak threshold, but it looks at the duration of the audio signal being above the second threshold and issues control signals accordingly.

Other implementations include, for example, video processor 210, switch 240 and processor 230 being combined into a single processor and memory 235 being combined with memory 245. In addition, all or many of the elements shown in FIG. 2 may be combined onto an ASIC, programmed into a programmable device such as an FPGA, or programmed into a general purpose processor. In addition much of the structure and functions shown and described in FIGS. 2 and 3 can be added to the camera/microphone 105. In this arrangement, camera/microphone 105 does not transmit any data over the network until a signal exceeds a threshold value. This reduces the amount of data sent over the network that would otherwise never be presented to the user or would be ignored. Alternatively, many of the structures and operations shown in FIGS. 2 and 3 may be incorporated into other devices such as a television or a computer. Also, the end-system need not have or require television 115. Instead, the user may use a portable device, such as a laptop computer, mobile telephone or personal digital assistant, to render the content.

Finally, the user is allowed to vary the threshold data. Thus, if the child is a noisy sleeper (i.e., snores loudly) the parent would want to increase the threshold value so as to reduce the number of false warnings displayed on television 115. This can be done via a remote control and a menu or via a switch connected to the STB 120, hub 125 or camera/microphone 105.

The process shown in FIG. 3 may be implemented in a general, multi-purpose or single purpose processor or processors. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

In the foregoing specification, specific illustrative system, devices and methods have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An electronic device comprising:
a first interface that receives a first signal;
a second interface that receives a second signal;
a processor that receives at least a portion of the second signal and compares a characteristic of the second signal to a threshold value and outputs a first control signal based upon the comparison; and
a video processor that receives the first control signal and outputs a first composite video signal comprised of data from the first signal and an icon in response to the first control signal.

2. The electronic device of claim 1 further comprising a memory that stores data representative of the icon.

3. The electronic device of claim 1, wherein the processor and the video processor are the same.

4. The electronic device of claim 1, wherein the second signal comprises an audio portion and a video portion.

5. The electronic device of claim 1 further comprising an infrared interface that receives a command and issues a second control signal in response to the received command to the video processor.

6. The electronic device of claim 1, wherein the video processor outputs a second composite video signal comprised of the data from the first signal and data from the second signal in a Picture-In-Picture mode.

7. A method of displaying video data comprising:
receiving a first audio/video signal;
receiving a second audio/video signal;
comparing a characteristic of the second audio/video signal against a threshold and outputting a first control signal based upon a result of the comparing; and
generating a composite video signal comprised of data from the first audio/video signal and an icon in response to the first control signal.

8. The method of claim 7 further comprising receiving a second control signal wherein the second control signal indicates a user's preference to view the second audio/video signal.

9. The method of claim 8 further comprising outputting the second audio/video signal in response to the second control signal and thereby cease generating the composite video signal.

10. A computer readable medium for controlling an audio/video device comprising instructions, wherein the instructions control the audio/video device to perform a method comprising:
receiving a first audio/video signal;
receiving a second audio/video signal;
comparing a characteristic of the second audio/video signal against a threshold and outputting a first control signal based upon a result of the comparing; and
generating a composite video signal comprised of data from the first audio/video signal and an icon in response to the first control signal.

11. The computer readable medium of claim 10 further comprising instructions, wherein the instructions control the audio/video device to perform a method further comprising receiving a second control signal wherein the second control signal indicates a user's preference to view the second audio/video signal.

12. The computer readable medium of claim 10 further comprising instructions, wherein the instructions control the audio/video device to perform a method further comprising outputting the second audio/video signal in response to the second control signal and thereby cease generating the composite video signal.
